(19) United States
(12) Patent Application Publication
(10) Pub. No.: US 2026/0342950 A1
(43) Pub. Date: Oct. 29, 2026

(54) METHOD AND ELECTRONIC DEVICE SYSTEM FOR GENERATING A STEREOSCOPIC VIEW OF AN OBJECT

(71) Applicant: Samsung Electronics Co., Ltd., Suwon-si (KR)

(72) Inventors: P Md Arbaz AHMED, Bangalore (IN); Anjali Sanjay ATHAVALE, Bangalore (IN); Lakshman Shashikant KHADAPKAR, Bangalore (IN); Prakash M CHANDRA, Bangalore (IN); Sidhartha Pratim DAS, Bangalore (IN); Sudip ROY, Bangalore (IN); Vishal Bhushan JHA, Bangalore (IN)

(21) Appl. No.: 19/368,356

(22) Filed: Oct. 24, 2025

Related U.S. Application Data
(63) Continuation of application No. PCT/KR2025/013015, filed on Aug. 26, 2025.

(30) Foreign Application Priority Data
Apr. 28, 2025 (IN) 20251040963

(51) Int. Cl. H04N 13/111; G06T 5/77; H04N 13/00; H04N 13/239; H04N 13/271

(52) U.S. Cl. CPC H04N 13/111; G06T 5/77; H04N 13/239; H04N 13/271; G06T 2207/10021; H04N 2013/0092

(57) ABSTRACT

According to an embodiment of the disclosure, the method for generating a stereoscopic view of an object, may include obtaining a first left eye image frame and a first right eye image frame based on input video frames. The method may include obtaining a second left eye image frame and a second right eye image frame. The method may include obtaining a center eye image frame. The method may include generating a background image frame. The method may include generating a third left eye image frame from the second left eye image frame, and the background image frame, and generating a third right eye image frame from the second right eye image frame, and the background image frame. The method may include generating the stereoscopic view of the object of interest from the third left eye image frame and the third right eye image frame.

### CROSS-REFERENCE TO RELATED APPLICATIONS

This application is a continuation of International Application No. PCT/KR2025/013015 designating the United States, filed on Aug. 26, 2025, in the Korean Intellectual Property Receiving Office and claiming priority to Indian Patent Application number 202541040963 filed on Apr. 28, 2025, the disclosures of each of which are incorporated by reference herein in their entireties.

### BACKGROUND

### Field

The disclosure relates to the field of stereoscopic viewing, and, for example, a method and an electronic device for generating a stereoscopic view of an object.

### Description of Related Art

Extended reality (XR) is an emerging field with significant potential in industries such as gaming, education, entertainment, and training, in which immersive experiences and engaging narratives are key essentials. In these environments, capturing a user's or viewer's attention and directing it to the right elements or information becomes is important for delivering an effective immersive experience.

In any narrative, information is conveyed by guiding a viewer's attention to the details that help progress a story. This principle holds across various mediums, in which the storyteller carefully selects what to show, how to frame it, and when to reveal key elements. In traditional 2-dimensional (2D) narratives, whether presented on screen or through static images, this is achieved by omitting non-essential details and focusing the viewer's attention within the confined boundaries of the frame. The frame itself acts as a boundary, controlling what the viewer sees and what remains out of view, thus directing perception and emotional response to the unfolding story.

However, in virtual reality (VR), attention shifts dynamically due to the medium's immersive nature. Unlike 2D, in which the frame is fixed and dictates the viewer's focus, VR offers an open, world-scale environment where users are free to look in any direction. This freedom eliminates the traditional constraints of framing, thus making attention guidance challenging.

Currently, VR developers often rely on 2D-inspired methods to focus user attention, such as dimming, occluding, or reducing the visibility of non-essential objects. FIG. 1 illustrates a pictorial representation 100 of focusing a user's attention during a virtual reality experience, in accordance with related art. As shown, the information is regulated by dimming other areas and spotlight 104 is used to highlight space 102 in order to draw or demand attention. However, this conventional methodology fails to fully harness the immersive nature of VR, thus disrupting the overall experience by hiding valuable context or creating disorienting visual shifts.

Therefore, a need exists for an improved solution that can address the above-mentioned issues and the limitations of the existing systems and methods.

### SUMMARY

This summary is provided to introduce a selection of concepts, in a simplified format, that are further described in the detailed description. This summary is neither intended to identify key or essential concepts nor is it intended for determining the scope of the disclosure.

According to an embodiment of the disclosure, the method for generating a stereoscopic view of an object, may include obtaining a first left eye image frame and a first right eye image frame based on input video frames, wherein the first left eye image includes a plurality of objects captured from a viewpoint of a left camera, and the first right eye image includes the plurality of objects captured from a viewpoint of a right camera. The method may include identifying an object of interest from among the plurality of objects, in each of the first right eye image frame and the first left eye image frame. The method may include obtaining a second left eye image frame and a second right eye image frame, respectively based on the first left eye image frame and the first right eye image frame, wherein the second left eye image frame and the second right eye image frame include the object of interest from among the plurality of objects. The method may include obtaining a center eye image frame by shifting at least one of the viewpoint of the left camera or the viewpoint of the right camera toward a center viewpoint. The method may include generating a background image frame by removing the object of interest from the center eye image frame and filling space of the removed object of interest. The method may include generating a third left eye image frame from the second left eye image frame, and the background image frame, and generating a third right eye image frame from the second right eye image frame, and the background image frame. The method may include generating the stereoscopic view of the object of interest from the third left eye image frame and the third right eye image frame.

According to an embodiment of the disclosure, an electronic device for generating a stereoscopic view of an object may be provided. The electronic device may comprise at least one processor comprising processing circuitry, and memory storing one or more instructions that, when executed by the at least one processor individually or collectively. The instructions that, when executed by the at least one processor individually or collectively, cause the electronic device to obtain a first left eye image frame and a first right eye image frame based on input video frames, wherein the first left eye image includes a plurality of objects captured from a viewpoint of a left camera, and the first right eye image includes the plurality of objects captured from a viewpoint of a right camera. The instructions that, when executed by the at least one processor individually or collectively, cause the electronic device to identify an object of interest from among the plurality of objects, in each of the first right eye image frame and the first left eye image frame. The instructions that, when executed by the at least one processor individually or collectively, cause the electronic device to obtain a second left eye image frame and a second right eye image frame, respectively based on the first left eye image frame and the first right eye image frame, wherein the second left eye image frame and the second right eye image frame include the object of interest from among the plurality of objects. The instructions that, when executed by the at least one processor individually or collectively, cause the electronic device to obtain a center eye image frame by moving at least one of the first left eye image frame or the first right eye image frame. The instructions that, when executed by the at least one processor individually or collectively, cause the electronic device to generate a background image frame by shifting at least one of the viewpoint of the left camera or the viewpoint of the right camera toward a center viewpoint. The instructions that, when executed by the at least one processor individually or collectively, cause the electronic device to generate a third left eye image frame from the second left eye image frame and the background image frame and generate a third right eye image frame from the second right eye image frame, and the background image frame. The instructions that, when executed by the at least one processor individually or collectively, cause the electronic device to provide the stereoscopic view of the object of interest from the third left eye image frame and the third right eye image frame.

According to the embodiment of the disclosure, a non-transitory computer readable storage medium containing instructions that when executed cause at least one processor of an electronic device may be provided.

To further clarify the advantages and features of the present disclosure, a more particular description will be provided by reference to specific non-limiting example embodiments thereof, which are illustrated in the appended drawings. It is appreciated that these drawings depict only example embodiments and are therefore not to be considered limiting of the scope of the disclosure. The disclosure will be described and explained with additional specificity and detail with the accompanying drawings.

### BRIEF DESCRIPTION OF THE DRAWINGS

These and other features, aspects, and advantages of certain embodiments of the present disclosure will be more apparent from the following detailed description, taken in conjunction with the accompanying drawings in which like characters represent like parts throughout the drawings, and in which:

FIG. 1 is an example pictorial representation of focusing a user's attention during virtual reality experience, in accordance with related art;

FIG. 2 illustrates an example environment for generating a stereoscopic view of an object, in accordance with various embodiments of the present disclosure;

FIG. 3 is a block diagram of an example system for generating a stereoscopic view of an object, in accordance with various embodiments of the present disclosure;

FIG. 4 is a schematic workflow for generating a stereoscopic view of an object of interest, according to various embodiments of the present disclosure;

FIG. 5 illustrates an example of segmenting foreground objects from centre eye image, according to various examples of the present disclosure;

FIG. 6 is a flow diagram of an example of generating a center eye image for input video frames captured in real-time, according to various embodiments of the present disclosure;

FIG. 7 illustrates an example of generating a center eye image in recorded input video frames, according to various embodiments of the present disclosure;

FIG. 8 illustrates an example of a stereoscopic view of an object of interest, according to various embodiments of the present disclosure;

FIGS. 9A and 9B illustrate a process flow of an example method for generating a stereoscopic view of an object, according to various embodiments of the present disclosure;

FIG. 10 illustrates an example of generating a stereoscopic view of an object, according to various embodiments of the present disclosure; and

FIGS. 11 and 12 illustrate example use cases of generating a stereoscopic view of an object, according to various embodiments of the present disclosure.

Further, skilled artisans will appreciate that elements in the drawings are illustrated for simplicity and are not necessarily drawn to scale. For example, the flow charts may illustrate example methods in terms of certain steps or operations involved to help improve understanding of aspects of the present disclosure. Furthermore, in terms of the construction of the device, one or more components of the device may be represented in the drawings by conventional symbols, and the drawings may show only those certain details that are pertinent to understanding the embodiments of the present disclosure so as not to obscure the drawings with details that will be readily apparent to those of ordinary skill in the art having the benefit of the description herein.

### DETAILED DESCRIPTION

For the purpose of promoting an understanding of the principles of the disclosure, reference will now be made to the various example embodiments and specific language will be used to describe the same. It will nevertheless be understood that no limitation of the scope of the disclosure is thereby intended

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments.

Accordingly, the term “some embodiments” is defined as meaning “no embodiment, or one embodiment, or more than one embodiment, or all embodiments.”

The terminology and structure employed herein are for describing, teaching, and illuminating some example embodiments and their specific features and elements and do not limit, restrict or reduce the spirit and scope of the claims or their equivalents.

More specifically, any terms used herein such as, but not limited to, “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Unless otherwise defined, all terms, and especially any technical and/or scientific terms, used herein may be taken to have the same meaning as commonly understood by one having ordinary skill in the art.

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfill the requirements of uniqueness, utility, and non-obviousness.

Use of the phrases and/or terms such as but not limited to “a first embodiment,” “a further embodiment,” “an alternate embodiment,” “one embodiment,” “an embodiment,” “multiple embodiments,” “some embodiments,” “other embodiments,” “a further embodiment”, “furthermore embodiment”, “additional embodiment” or variants thereof do NOT necessarily refer to the same embodiments. Unless otherwise specified, one or more particular features and/or elements described in connection with one or more embodiments may be found in one embodiment or may be found in more than one embodiment, or may be found in all embodiments, or may be found in no embodiments.

Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any feature and/or element described in the context of separate embodiments may alternatively be realized as existing together in the context of a single embodiment.

Any particular and all details set forth herein are used in the context of some embodiments and therefore should NOT be necessarily taken as limiting factors to the attached claims. The attached claims and their legal equivalents can be realized in the context of embodiments other than the ones used as illustrative examples in the description below.

Further, skilled artisans will appreciate those elements in the drawings that are illustrated for simplicity and are not necessarily drawn to scale. For example, the flow charts illustrate the method in terms of certain steps or operations involved to help improve understanding of aspects of the present disclosure. Furthermore, in terms of the construction of the device, one or more components of the device may be represented in the drawings by conventional symbols, and the drawings may show only those details that are pertinent to understanding the embodiments of the present disclosure so as not to obscure the drawings with details that will be readily apparent to those of ordinary skill in the art having the benefit of the description herein.

In virtual reality (VR), creating an immersive and intuitive user experience requires effective methods to guide attention within a virtual environment. In VR, guiding attention often involves omitting or occluding irrelevant information from the virtual environment, which can disrupt immersion. This approach may lead to a loss of spatial context and engagement. The present disclosure provides a solution that maintains the full information in the VR space while meaningfully highlighting key elements. The VR space may, for example, refer to the virtual environment created in VR where a user may interact with digital objects and surroundings as if they were real.

Example embodiments of the present disclosure may, for example, enhance VR's storytelling and instructional potential by subtly guiding and influencing focus, leveraging the VR's stereoscopic qualities.

Example embodiments of the present disclosure may, for example, provide a solution that maintains real-world scale and immersion while effectively highlighting critical objects or areas (mentioned hereinafter as an object of interest or a region of interest) during VR experience.

Example embodiments of the present disclosure may, for example, render important objects in stereoscopy, thus, preserving immersion while effectively directing the user focus.

Example embodiments of the present disclosure may, for example, utilize VR's unique capabilities, such as spatial audio, dynamic lighting, and an environmental cue, to provide more natural and engaging ways to direct the user's attention, enriching both narrative experiences and educational content within extended reality environments.

Example embodiments of the present disclosure will be described below in detail with reference to the accompanying drawings.

The present disclosure describes example methods and systems for generating a stereoscopic view of an object. In a VR device, the stereoscopic view of the object is a three-dimensional (3D) representation created by presenting two slightly different images (from left eye and right eye) mimicking natural depth perception. Thus, presenting the two slightly different images allows the VR device to produce a realistic sense of depth, making the object appear three-dimensional. The present disclosure selectively displays certain objects or areas in the stereoscopic view while keeping the rest of the scene in a monoscopic view. The “scene” may, for example, refer to an entire environment or setting depicted in a video or a virtual space. The scene may include all the objects, backgrounds, lighting, and spatial arrangements that create a cohesive visual narrative. The monoscopic view is a flat, two-dimensional (2D) representation of the scene in which both eyes see same image, without any depth cues. For instance, during the VR experience using the VR device, the stereoscopic view is used for critical or designated or particular objects (which may also be referred as “object of interest”) such as a burning building and emergency vehicles in the scene to make them stand out in 3D. Meanwhile, background of the scene, such as distant buildings and the sky, remains in the monoscopic view to keep the scene visually simple and reduce cognitive load. Further, the monoscopic view is made using a center eye image. The center eye image in VR may, for example, refer to an image that represents a viewpoint positioned between the left eye and the right eye perspectives, typically aligning with the user's central line of sight. The center eye image can be used to highlight the object of interest in the scene. The object of interest may be a specific item, entity, or feature within the scene or environment that is the focus of attention, analysis, or interaction. For instance, in a VR gaming environment, the object of interest might be an enemy character that a player needs to defeat, or a treasure chest that the player aims to collect.

The technology of the present disclosure may effectively guide users' attention without having to resort to occlusion of information in VR space. This enables applications ranging from simple storytelling in VR to intuitive onboarding in VR and even field guidance in augmented reality (AR).

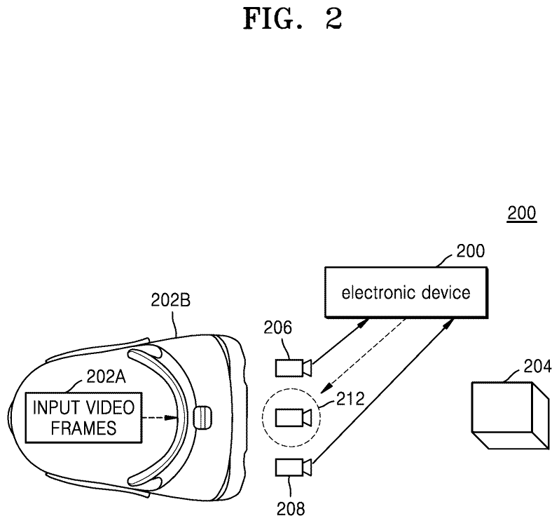

FIG. 2 illustrates an example environment 200 for generating a stereoscopic view of an object 204, in accordance with various embodiments of the present disclosure.

As shown in the figure, a Head Mounted Display (HMD) device 202B that receives input video frames 202A (with an object 204 included in the input video frames 202A (alternately referred to hereinafter as object of interest or OOI)) may include a camera 206 positioned in the HMD 202B to provide a first left eye image frame, a camera 208 positioned in the HMD 202B to provide a first right eye image frame, and a virtual third center eye camera 212 in the HMD 202B.

According to an embodiment of the disclosure, the first left eye image frame may refer to an image of the object captured through the camera 206. For example, the first left eye image frame may represent an image of a scene external to the user, such as the surrounding environment, captured from a viewpoint of a left camera 206. The camera 206 may be positioned on the left side of the HMD 202B.

According to an embodiment of the disclosure, the first right eye image frame may refer to an image of the object captured through the camera 208. For example, the first right eye image frame may represent an image of a scene external to the user, such as the surrounding environment, captured from a viewpoint of a right camera 208. The camera 208 may be positioned on the right side of the HMD 202B.

According to an embodiment of the disclosure, the HMD device 202B receives input video frames 202A, which include the OOI 204 captured from two perspectives: one from the camera 206 positioned to provide the first left eye image frame and another from the camera 208 positioned to provide the first right eye image frame. The environment also includes an electronic device 210 that communicates with the cameras 206 and 208 of the HMD 202B to selectively render OOI 204 as the center eye image frame. Further, the electronic device 210 converts the input video frames 202A into the stereoscopic image or video.

According to an embodiment of the disclosure, the electronic device 210 may include software, hardware (including various circuits and circuitry), a combination of software and hardware, a in-built application on the HMD device 202B or an application to be installed and operated on the HMD device 202B in communication with a network interface. The electronic device 210 may also be available via a cloud-based server and available remotely from the HMD device 202B.

In an example embodiment in which the electronic device 210 is located outside the HMD device 202B, a network interface (not shown) (including, e.g., network interface circuitry) may be configured to provide network connectivity and enable communication between the electronic device 210 and the HMD device 202B. The network connectivity may be provided via a wireless connection or a wired connection. For example, the network connectivity may be provided via cellular technology, such as 3rd Generation (3G), 4^{th} Generation (4G), 5^{th} Generation (5G), pre-5G, 6^{th} Generation (6G), Bluetooth, Local Area Network (LAN), Wi-Fi, cable, or any other wired/wireless communication technology.

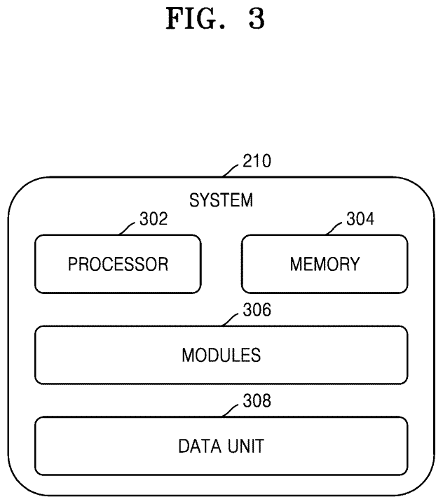

FIG. 3 is a block diagram of the electronic device 210 for generating the stereoscopic view of the object, in accordance with various embodiments of the present disclosure. The electronic device 210 may include one or more processors 302 (hereafter referred to as the processor 302 and including, e.g., processing circuitry), memory 304, one or more modules 306, and a data unit 308. In an example embodiment, the processor 302 may be operatively coupled to each of the memory 304, the modules 306, and the data unit 308. The processor 302 may execute a software program, such as generated code (i.e., programmed) to perform desired operation(s). The processor 302 may implement various techniques such as, but not limited to, image processing, data extraction, Artificial Intelligence (AI), Machine Learning (ML), Deep Learning (DL), and so forth to achieve the desired objective(s).

In various embodiments, the memory 304 may be communicatively coupled to the processor 302. The memory 304 may be configured to store data, and instructions executable by the at least one processor 302. In an embodiment, the memory 304 may communicate via a bus within the electronic device 210. The functions, acts or tasks illustrated in the figures or described may be performed by the processor 302, for example, by executing the instructions stored in the memory 304. The functions, acts or tasks are independent of the particular type of instructions set, storage media, processor or processing strategy and may be performed by software, hardware, integrated circuits, firmware, micro-code and the like, operating alone or in combination.

The processor 302 includes one or more processing devices, such as one or more microprocessors, microcontrollers, digital signal processors (DSPs), application specific integrated circuits (ASICs), or field programmable gate arrays (FPGAs). In some embodiments, the processor 302 includes one or more of a central processing unit (CPU), an application processor (AP), a communication processor (CP), a graphics processor unit (GPU), or a neural processing unit (NPU). The processor 302 is able to perform control on at least one of the other components of the electronic device 210 and/or perform an operation or data processing relating to communication or other functions. As described below, the processor 302 may perform one or more functions related to image visual enhancement for XR or other applications.

The processor 302 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing a variety of the recited/disclosed functions, e.g., in a distributed manner. At least one processor may execute program instructions to achieve or perform various functions.

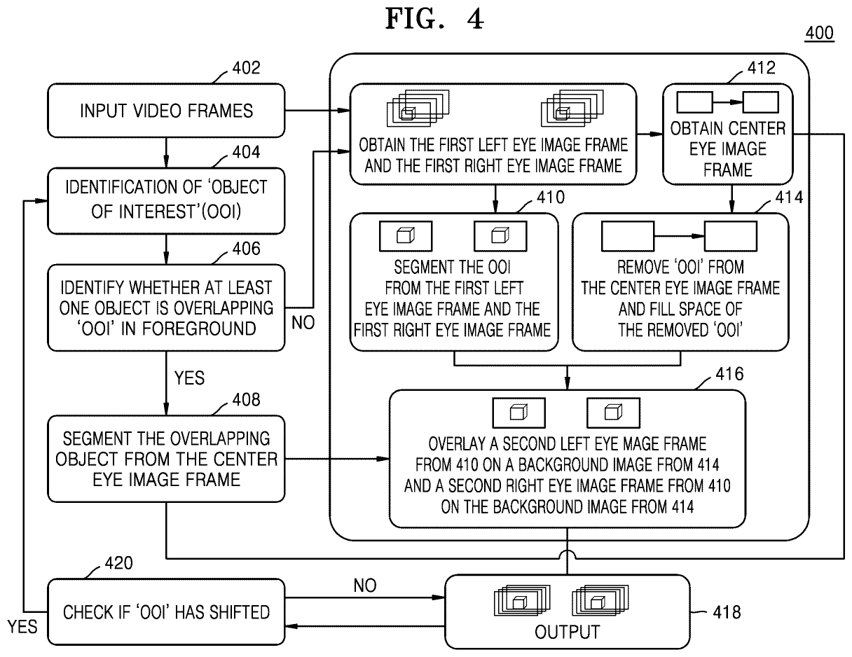

The modules 306, amongst other things, include routines, programs, objects, components, data structures, etc., which perform particular tasks or implement data types. The modules 306 may also be implemented as, signal processor(s) (including, e.g., signal processing circuitry), state machine(s), logic circuitries, any other device, circuit, or component that manipulates signals based on operational instructions. Further, the modules 306 may be implemented in hardware, instructions executed by a processing unit (including, e.g., processing circuitry), or by a combination thereof. The modules 306 enable the electronic device 210 to perform the features/functions of the present disclosure, as discussed and explained in detail in conjunction with FIGS. 4-12 in the forthcoming paragraphs.

In an embodiment, the data unit 308 serves, amongst other things, as a repository for storing processed data, received, and generated by one or more of the modules 306. In an embodiment, the data unit 308 may be implemented using a portion of the memory 304 and may serve as a storage module for storing data received or generated by one or more of the modules 306.

In an embodiment of the present disclosure, the processor 302 via the modules 306 is configured to execute machine-readable instructions (software) which perform the processes/functions of the electronic device 210 within the scope of the present disclosure as described in forthcoming paragraphs.

In an embodiment, the HMD device 202B processes the input video frames 202A, which contain the visual data for display. The HMD device 202B may provide the input video frames 202A to the electronic device 210. Within the input video frames 202A, the object of interest 204 is highlighted, which serves as focal point in the scene to attract the user's attention. As discussed earlier, the OOI 204 is captured from two perspectives: one from the camera 206 positioned to provide the first left eye image frame and another from the camera 208 positioned to provide the first right eye image frame.

In an embodiment, the electronic device 210 may receive the first left eye image frame and the first right eye image frame from the input video frames 202A. In an embodiment, the first left eye image frame and the first right eye image frame from the input video frames 202A may include a plurality of objects.

In a non-limiting example, the input video frames 202A may include stereoscopic video captured from a 3-dimensional (3D) camera or from the HMD 202B equipped with a stereo camera (e.g., cameras (206, 208)). Stereoscopic video is a type of video that creates an illusion of depth, making it appear three-dimensional (3D) when viewed with an appropriate device such as the HMD 202B. The 3-D camera captures visual content with depth perception using dual lenses or multiple cameras positioned slightly apart to record two slightly different images-one for the left eye (e.g., the first left eye image frame) and one for the right eye (e.g., the first right eye image frame)-generating a stereoscopic effect. HMD 202B is a device worn on the head that displays 3D content, using, for example, separate screens for each eye (the first left eye image frame and the first right eye image frame) to present stereoscopic images.

The input video frames 202A may also include video output generated entirely from a fully constructed VR environment. For example, the video output may be an entire museum, including its galleries and artwork, created in the VR environment. In the video output, the user may explore the museum as if he/she is physically there, with realistic lighting, textures, and spatial audio enhancing the immersive experience.

The plurality of objects corresponds to multiple items within the input video frames 202A that are visible from slightly different perspectives to generate the 3D effect. For example, in a VR simulation of a busy city street, both the first left eye image frame and the first right eye image frame might display objects such as a red sports car, a streetlamp, and pedestrians, with the right eye frame showing these elements slightly offset to mimic natural depth perception.

The electronic device 210 may identify the OOI 204 from among the plurality of objects, in each of the first right eye image frame and the first left eye image frame. In an embodiment, the electronic device 210 may identify the OOI 204 based on one or more of an eye gaze of the user by the HMD 202B, a head gaze of the user by the HMD 202B, a pointer, or a pre-defined marking in the input video frames 202A by a developer. Thus, the OOI 204 may be identified in the input video frames 202A based on the eye gaze of the user, where the HMD 202B tracks direction of the user's eyes to determine which object they are focusing on. For example, in a VR game in which a player's attention is directed at an enemy character, the enemy character may be an OOI. Alternatively, the OOI 204 may be identified in the input video frames 202A based on the head/eye gaze of the user, where the HMD detects the user's head orientation or eye gaze direction to identify the OOI 204. For example, when the user looks at a specific virtual dashboard in a simulation, the dashboard may an OOI. Additionally, the OOI 204 may be identified through a pointer, such as a VR controller's laser pointer, or by a pre-defined marking in the input video frames, for example a highlighted area around a target object in an augmented reality (AR) application. Further, the OOI 204 may appear in foreground, which refers to the part of the virtual environment that appears closest to the user.

The electronic device 210 may identify Regions of Interest (ROIs) in each of the first right eye image frame and the first left eye image frame that requires recognizing objects. The ROI may, for example, refer to specific areas or regions within an image frame (from the input video frames 202A) for focused analysis, often defined by geometric boundaries such as rectangles or polygons. For example, if the input video frames 202A focus on an entrance of a building, then the ROI could be defined as a rectangular boundary around a doorway to monitor for unauthorized access. The use of the term OOI includes the term ROI, as the context may require.

Further, in scenarios in which HMDs are not used, this information may be manually recorded using different types of pointers or input devices to track a user's focus during the input video frames 202A capturing process. In an embodiment, in the stereoscopic video, the OOI/ROI 204 may be identified in real time. In cases in which the stereoscopic view is streamed to another device, such as a tablet, user interactions such as pointers, taps, or touch gestures may serve as input to identify the OOI/ROI 204 effectively. In an embodiment, for experiences with predefined user journeys, the OOI/ROI 204 may be marked or encoded during a content development phase, thus allowing for precise control over which areas are highlighted or identified, ensuring that the experience aligns with the intended user interactions without relying solely on real-time tracking.

In an embodiment, the electronic device 210 may generate a second left eye image frame with the object of interest 204, from the first left eye image frame. The electronic device 210 may generate a second right eye image frame with the object of interest 204, from the first right eye image frame.

According to an embodiment of the disclosure, the electronic device 210 may obtain the second left eye image frame by segmenting the object of interest from the first left eye image frame. The electronic device 210 may obtain the second right eye image frame by segmenting the object of interest from the first right eye image frame.

According to an embodiment of the disclosure, the electronic device 210 may obtain the center eye image frame by using at least one of the first left eye image frame or the first right eye image frame. To generate the center eye image frame, the electronic device 210 may generate a depth map for the object of interest 204 in each of the first left eye image frame and the first right eye image frame. The depth map may, for example, refer to a graphical representation that shows distance of the plurality of objects in the scene from the user. The depth map may use varying shades of gray in which darker areas indicate objects farther away and lighter areas represent closer objects. The depth map may be used to enhance 3D perception by providing spatial context, enabling accurate detection, tracking, and interaction with objects in the scene.

For instance, the depth map for the OOI 204 may be generated by Light Detection and Ranging (LiDAR) or depth information from hardware (including circuitry) and depth estimation artificial intelligence (AI) or a depth map generator.

The electronic device 210 may generate a plurality of depth clusters from the generated depth map for the object of interest. The depth clusters may, for example, refer to groups of pixels within the depth map that share similar depth values, effectively categorizing the plurality of objects based on their distance from the user. The depth map may include clusters of pixels whose depth values fall within a defined (e.g., pre-defined) range from a reference depth value. When generating the depth clusters for the OOI, the depth map is analyzed to identify areas where depth information is consistent, allowing for segmentation of the scene into distinct layers or clusters. This process helps in isolating the OOI from the background.

The electronic device 210 may obtain an interpupillary distance (IPD) by segmenting the plurality of depth clusters. The IPD is the distance between the centers of the pupils of the eyes. The IPD affects how each eye perceives depth and 3D images. By accurately measuring the IPD, devices (such as the HMD device 202B) can adjust the center eye image frame to ensure that the visual content aligns correctly with the user's natural eye position, enhancing depth perception and reducing visual discomfort.

The IPD is determined from depth clusters by measuring disparity between corresponding points in the first left eye image frame and the first right eye image frame within the depth map. By analyzing the disparity across the depth clusters, the user's IPD may be obtained.

Further, the electronic device 210 may generate the center eye image frame by shifting the viewpoint of the left camera toward a center viewpoint by half of the IPD. Also, the electronic device 210 may generate the center eye image frame by shifting the viewpoint of the right camera toward a center viewpoint by half of the IPD.

According to an embodiment of the disclosure, in an embodiment, the electronic device 210 may identify one or more overlapping objects with the object of interest from the center eye image frame. The one or more overlapping objects may, for example, refer to items that partially cover the object of interest from the user's center eye perspective. For example, in a VR scene with a cup on a table, the second left eye image frame may clearly show the cup, however, a book on the table may partially overlap the cup's left side. When the user moves his head slightly to the right, the second right eye image frame shows the cup again, however, this time the book covers more of the cup due to the changed angle. The book is the overlapping object which partially obscures the cup in both the second left eye image frame and the second right eye image frame. The book in the foreground is causing the cup (the OOI) appear to be partially hidden or in background.

In response to identification of the one or more overlapping objects, the electronic device 210 may segment out the one or more overlapping objects from the center eye image frame. The electronic device 210 may overlay the one or more of overlapping objects on top of the third left eye image frame and the third right eye image frame. For instance, in the example mentioned above, the book is segmented from both the first left eye image frame and the first right eye image frame, then the third left eye image frame and the third right eye image frame may be generated and later the book is overlayed on the generated third left eye image frame and the third right eye image frame.

In an embodiment, the electronic device 210 may generate a background image frame by removing the object of interest 204 from the center image frame and filling space of the object of interest. The background image may, for example, refer to a part of visual field that appears farthest from the user, including distant objects such as landscapes, skies, or walls. The background image may provide context and depth to the virtual environment. In the center eye image frame (e.g., the center eye image frame is generated from the first left eye image frame and the first right frame), the background may help establish spatial layout and depth cues. Further, in a non-limiting example, to fill the space of the object of interest in the background image frame, state of the art (SOTA) models, such as deep learning-based inpainting networks may be used. The SOTA models fill in the space often using context from the surrounding areas.

The electronic device 210 may generate a third left eye image frame and a third right eye image frame from the second left eye image frame, the second right eye image frame, and the background image frame. The third left eye image frame and the third right eye image frame from second left eye image frame refer to the two slightly offset images generated to simulate depth perception in VR. The third left eye image frame represents view captured from the left eye's perspective, while the third right eye image frame represents the view from the right eye's perspective.

Lastly, the electronic device 210 may generate the stereoscopic view of the object of interest 212 from the third left eye image frame and the third right eye image frame.

Thus, the present disclosure may solve the problems of guiding attention in VR in a non-destructive way as well as selectively rendering certain areas or objects in the stereoscopic view while rendering the rest of the scene in the monoscopic view.

FIG. 4 illustrates a schematic example workflow 400 for generating the stereoscopic view of the OOI 204, according to various embodiments of the present disclosure.

In an embodiment, the processor 302 receives the input video frames 202A, which contain the visual data for display. The input video frames 202A includes the OOI 204 which serves as focal point in the scene to attract the user's attention. As discussed earlier, the OOI 204 is captured from two perspectives: one from the camera 206 positioned to provide the first left eye image frame and another from the camera 208 positioned to provide the first right eye image frame.

At block 402, the processor 302 may obtain the input video frames 202A. At block 405, the processor 302 may receive the first left eye image frame and the first right eye image frame from the input video frames 202A. In a non-limiting example, the input video frames 202A may include stereoscopic video captured from the 3D camera or from the HMD 202B equipped with cameras (206, 208). Additionally, the input video frames 202A may also include video output generated entirely from a fully constructed VR environment.

At block 404, the processor 302 may identify the OOI 204 from the first left eye image frame and the first right eye image frame. The OOI 204 may be identified in the input video frames 202A based on, for example, the eye gaze of the user, where the HMD 202B tracks direction of the user's eyes to determine which object they are focusing on. In an embodiment, the OOI 204 may be identified in the input video frames 202A based on the head gaze of the user, where the HMD detects the user's head orientation to identify the OOI. In an embodiment, the OOI may be identified through a pointer, such as a VR controller's laser pointer, or by a pre-defined marking in the input video frames, for instance a highlighted area around a target object in an augmented reality application.

In an embodiment, the processor 302 may identify the ROIs in each of the first right eye image frame and the first left eye image frame. The ROI refers to specific areas or regions within an image frame (from the input video frames 202A) for focused analysis, often defined by geometric boundaries such as rectangles or polygons. The use of the term OOI includes the term ROI, as the context may require.

At block 406, the processor 302 may identify for one or more objects overlapping the OOI in the foreground. The one or more overlapping objects may, for example, refer to items that partially cover the object of interest from the user's center eye perspective. The foreground may refer to the part of the virtual environment that appears closest to the user. The foreground may be important for interaction, as it typically contains the OOI 224 that the user may focus on or manipulate.

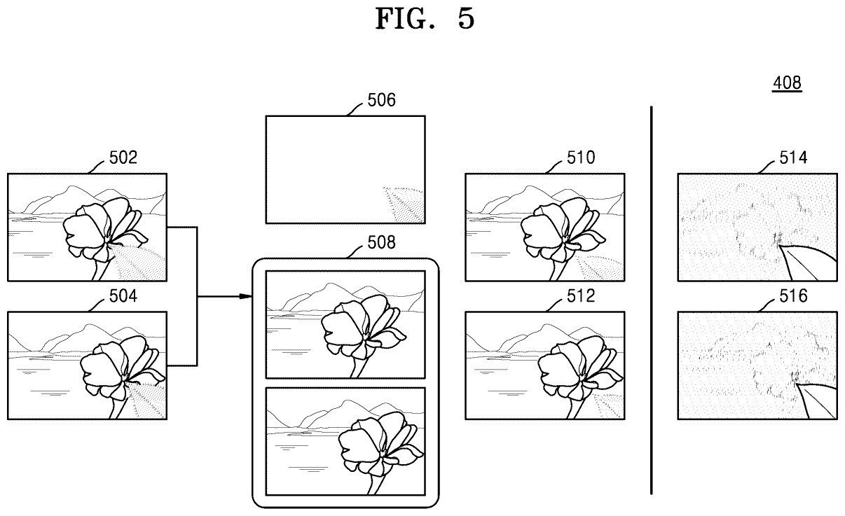

If yes, then at block 408, the processor 302 may identify the one or more overlapping objects from the center eye image and segment the overlapping objects to use the overlapping object as an overlay on the top. The detailed explanation of the process of segmenting foreground objects from center eye image is explained in FIG. 5.

At step 408, the processor 302 may segment out the one or more overlapping objects using, for example, the SOTA technique. The processor 302 may segment the one or more overlapping objects from the center eye image frame. The processor 302 may then generate the center image and overlay the one or more overlapping objects with the second left eye image frame and background image frame or with the second right eye image frame and background image at step 416.

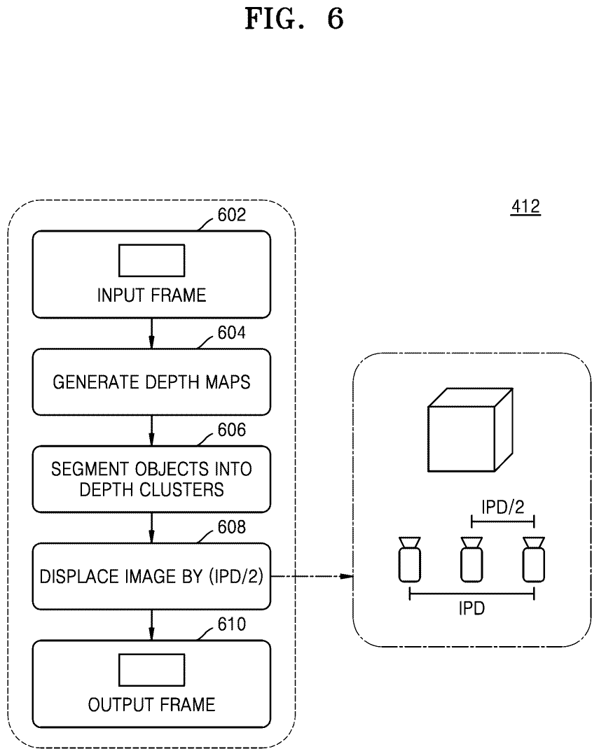

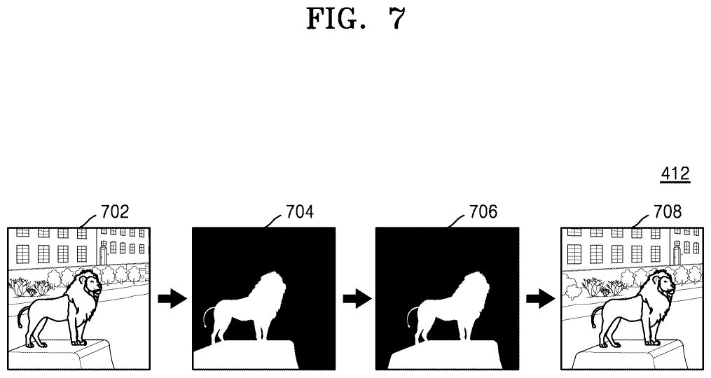

Further, at step 412, the processor 302 may generate the center image frame by shifting at least one of the viewpoint of the left camera or the viewpoint of the right camera toward a center viewpoint. The detail explanation of the process of generating center eye image frame is explained in FIGS. 6 and 7.

At step 414, the processor 302 may generate the background image frame by removing the OOI 204 from the center eye image frame and filling up space of the OOI 204.

To avoid visual duplication of the OOI 204 in the center eye image frame, the OOI 204 is removed and a fill is generated in its place. The fill can range from a lo-fi blur and fill to a hi-fi AI generated fill from the context. Further, in a non-limiting example, to fill the space of the object of interest in the background image frame, the SOTA models, such as deep learning-based inpainting networks may be used. The SOTA models fill in the space often using context from the surrounding areas.

At step 416, the processor 302 may overlay the second left eye image frame and the second right eye image frame on the center eye image frame. Overlaying the second left eye image frame and the second right eye image frame on the center eye image frame may, for example, refer to the process of combining images captured from both the left and right eye perspectives with a central view to create a cohesive, stereoscopic 3D scene. The processor 302 may overlay the segmented ‘foreground’ objects, if applicable as explained in step 408.

At step 418, the processor 302 may generate the stereoscopic view of the OOI from the third left eye image frame and the third right eye image frame. The third left eye image frame and the third right eye image frame may, for example, refer to the two slightly offset images generated to simulate depth perception in VR. The third left eye image frame represents view captured from the left eye's perspective, while the third right eye image frame represents the view from the right eye's perspective.

At step 420, the processor 302 may check if the OOI has shifted. If yes, then the processor 302 may restart the process from the steps 404 onwards. If no, the processor 302 may stop the process. For example, if the user is initially looking at a virtual painting on a wall in the VR scene, the painting is the OOI. As the user moves his head or changes his focus towards a window in the scene, the processor 302 may recognize that the OOI has shifted because the painting is no longer in center of the user's visual field. In such a case, the processor 302 may restart the steps 404 onwards considering the window as the OOI.

FIG. 5 illustrates an example of segmenting foreground objects 408 from centre eye image, according to various embodiments of the present disclosure.

As shown, image 502 represents the first left eye image frame and image 504 represents the first right eye image. Further, both the first left eye image frame and the first right eye image frame are received from the input video frames 202A. The input video frames 202A processed for segmentation of foreground objects are unprocessed input video frames 202A received by the processor 302.

For example, the images 502 and 504 may be referred to as the first left eye image frame and the first right eye image frame. The images 502 and 504 include an overlapping object e.g., a leaf on the OOI e.g., a flower. The overlapping object (e.g., the leaf) is partially covering the OOI (e.g., the flower) from the user's center eye perspective. The foreground refers to the part of the virtual environment that appears closest to the user. Thus, it is necessary to process the overlap object in such a way that it does not hide the OOI.

Initially, the processor 302 may segment out the overlapping object (e.g., the leaf) from the center eye image frame.

Image 506 represents the segmented image of the overlapping object from center eye image frame.

Image 508 represents processed the second left eye image frame and the second right eye image frame with a common background as the center eye image frame.

Images 510 and 512 represent resulting the first left eye image frame and first right eye image frame with the overlapping object (e.g., the leaf) on top of the background image frame. Thus, as shown in images 510 and 512, the leaf is overlayed on the background image frame with the flower as the OOI. The overlapping object (e.g., the leaf) is not hiding the OOI (e.g., the flower), thus, keeping the focus of the user intact.

Further, images 514 and 516 represent a case in which the user's focus shifts from the initial OOI (e.g., the flower) to the overlapping object (e.g., the leaf). In such a case, the previously segmented overlapping object is split in two while the previous OOI merges and become a part of the background image. As shown, the previous OOI (e.g., flower) is now blur representing the background, since new OOI is the leaf.

FIG. 6 is illustrates a flow diagram 600 of an example of generating a center eye image frame for the input video frames captured in real-time, according to various embodiments of the present disclosure.

At block 602, the processor 302 may receive the input video frames 202A in real-time. In a non-limiting example, the input video frames 202A may include stereoscopic video captured from a 3D camera or from the HMD 202B equipped with cameras (206, 208). Additionally, the input video frames 202A may also include video output generated entirely from a fully constructed VR environment.

At block 604, the processor 302 may generate a depth map for the OOI 204 in each of the first left eye image frame and the first right eye image frame. The depth map may, for example, refer to a graphical representation that shows distance of the plurality of objects in the scene from the user. The depth map may use varying shades of gray in which darker areas indicate objects farther away and lighter areas represent objects that are closer. The depth map may be used to enhance 3D perception by providing spatial context, enabling accurate detection, tracking, and interaction with objects in the scene. For example, the depth map for the OOI 204 may be generated by LiDAR or depth information from hardware and depth estimation AI or a depth map generator.

At block 606, the processor 302 may generate a plurality of depth clusters by segmenting the generated depth map for the object of interest. The depth clusters may refer to groups of pixels within the depth map that share similar depth values, effectively categorizing the plurality of objects based on their distance from the user. When generating the depth clusters for the OOI, the depth map is analyzed to identify areas where depth information is consistent, allowing for the segmentation of the scene into distinct layers or clusters. This process helps in isolating the OOI from the background.

At block 608, the processor 302 may obtain the IPD by segmenting the plurality of depth clusters and generate the first center eye image frame and the second center eye image frame by shifting the first left eye image frame towards center by half of the IPD and the first right eye image frame towards center by half of the IPD. The IPD is determined from depth clusters by measuring the disparity between corresponding points in the first left eye image frame and the first right eye image frame within the depth map. By analyzing the disparity across the depth clusters, the user's IPD may be obtained. By accurately measuring the IPD, the processor 302 may adjust the first center eye image frame and the second center eye image frame to ensure that the visual content aligns correctly with the user's natural eye position, thus enhancing depth perception and reducing visual discomfort.

Further, since the render is happening in real time, the camera angles/positions (in the HMD or 3D camera 202B) may be shifted. The camera moves by (IPD/2) mm from left eye camera and (IPD/2) mm from the right eye camera.

At block 610, the processor 302 may obtain the center eye image frame by shifting the at least one of the first left eye image frame or the first right eye image frame towards center by half of the IPD.

FIG. 7 illustrates an example of generating a center eye image in recorded input video frames, according to various embodiments of the present disclosure.

In recorded input video frames, since the first left eye image frame and the first right eye image frame have already been captured, there is no freedom to move around the camera at this point. Hence, at least one of the first left eye image frame or the first right eye image is used to generate depth maps.

Thus, image 702 represents the input frame e.g., at least one of the first left eye image frame and the first right eye image frame. The electronic device may indicate ‘Lion’ as the OOI in the image 702. The processor 302 may receive the input frame 702 and generate the depth maps as shown in image 704. The depth map may, for example, refer to the graphical representation that shows the distance of the plurality of objects in the scene from the user, for instance, flag, building, stairs and pillar as shown in image 702. The depth map uses varying shades of gray in which darker areas indicate objects farther away and lighter areas represent objects that are closer. The depth map may be used to enhance 3D perception by providing spatial context, enabling accurate detection, tracking, and interaction with objects in the scene. For instance, the depth map for the OOI 204 (Lion) may be generated by LiDAR or depth information from hardware and depth estimation AI or depth map generator. Thereafter, the processor 302 may generate a plurality of depth clusters by segmenting the generated depth map for the object of interest. The depth clusters are segmented in order to maintain parallax when the viewpoint is shifted. The depth clusters may refer to groups of pixels within the depth map that share similar depth values, effectively categorizing the plurality of objects based on their distance from the user. When generating the depth clusters for the OOI, the depth map is analyzed to identify areas where depth information is consistent, allowing for the segmentation of the scene into distinct layers or clusters. This process helps in isolating the OOI from the background.

Thereafter, the processor 302 may obtain the IPD by segmenting the plurality of depth clusters and generate the center image frame by shifting at least one of the viewpoint of the left camera or the viewpoint of the right camera toward a center viewpoint. The IPD is determined from depth clusters by measuring disparity between corresponding points in the first left eye image frame and the first right eye image frame within the depth map. By analyzing the disparity across the depth clusters, the user's IPD may be obtained.

As shown, image 706 represents the first left eye image frame that displaces itself to IPD/2 mm to the right to obtain the center eye image 708.

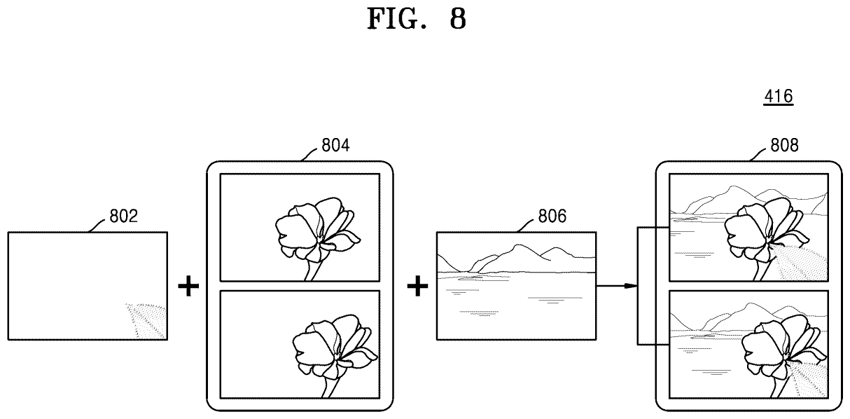

FIG. 8 illustrates an example of the stereoscopic view of the object of interest, according to various embodiments of the present disclosure.

The processor 302 may receive the first left eye image frame and the first right eye image frame from input video frames (202A) and identify the OOI (204) from among the plurality of objects, in each of the first right eye image frame and the first left eye image frame. As shown in FIG. 8, the OOI is the flower. Further, the processor 302 also checks for one or more overlapping objects, which in this case is the leaf.

As shown, image 802 depicts segmented overlapping object, for example, the leaf, identified in the input video frames 202A.

Image 804 depicts the second left eye image frame with the OOI and the second right eye image frame with OOI. The second left eye image frame may include the OOI among the plurality of objects included in the first left eye image. The second right eye image frame may include the OOI among the plurality of objects included in the first right eye image.

The processor 302 may generate the center image frame by shifting at least one of the viewpoint of the left camera or the viewpoint of the right camera toward a center viewpoint by half of the IPD. The processor 302 may generate the background image frame by removing the OOI 204 from the center image frame and filling up space of the OOI 204. To avoid visual duplication of the OOI 204 in the center eye image frame, the OOI 204 is removed, and a fill is generated in its place. The fill can range from the lo-fi blur and fill to the hi-fi AI generated fill from the context. Further, in a non-limiting example, to fill the space of the object of interest in the background image frame, the SOTA models, such as deep learning-based inpainting networks may be used. The SOTA models fill in the space often using context from the surrounding areas.

Image 806 depicts the background image frame generated from the center eye image frame, as a monoscopic view of background without the OOI.

The processor 302 may provide the stereoscopic view of the OOI (204) based on the third left eye image frame and the third right eye image frame. The third left eye image frame is generated from the second left eye image frame, the background image frame and the overlaying of the overlapping object. The third right eye image frame is generated from the second right eye image frame, the background image frame and the overlaying of the overlapping object.

Image 808 represents the stereoscopic view of the OOI from the third left eye image frame and the third right eye image frame.

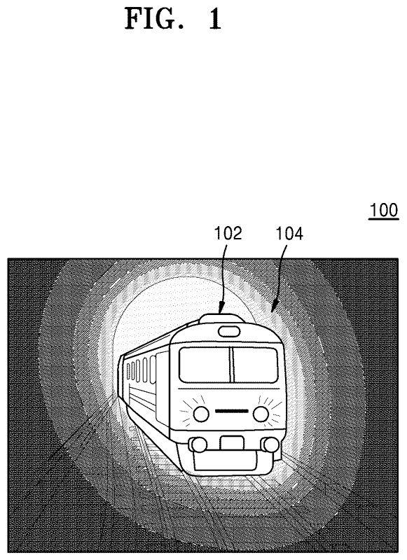

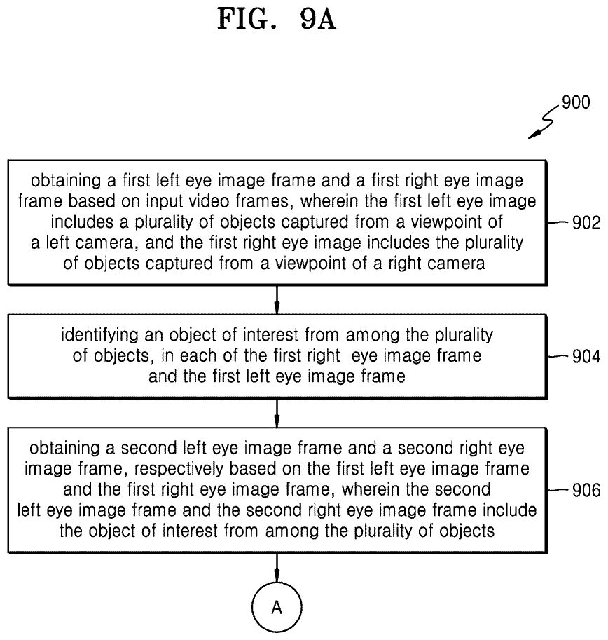

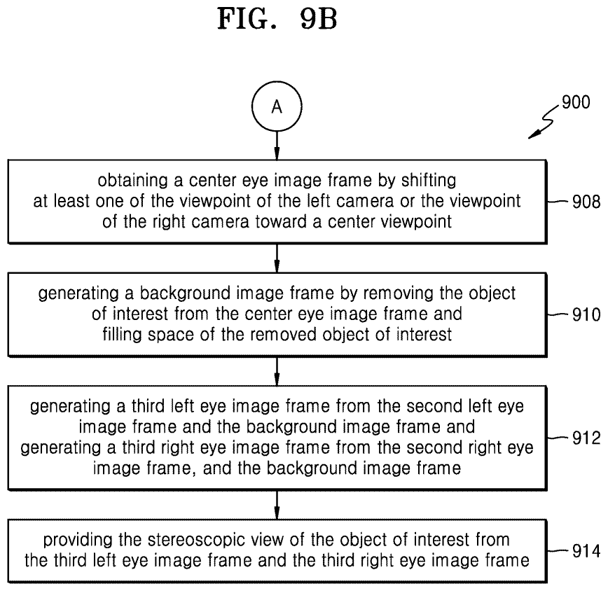

FIGS. 9A and 9B illustrate a process flow of an example method 900 for generating the stereoscopic view of the object 204, according to various embodiments of the present disclosure. The method 900 may be a computer-implemented method executed, for example, by the processor 302. For the sake of brevity, constructional and operational features of the electronic device 210 that are already explained in the description of FIGS. 1-8 are not repeated in detail in the description of FIGS. 9A and 9B.

At step 902, the method 900 may include receiving the first left eye image frame and the first right eye image frame from the input video frames 202A. In a non-limiting example, the input video frames 202A may include stereoscopic video captured from a 3D camera or the HMD 202B equipped with cameras (206, 208). Additionally, the input video frames 202A may also include video output generated entirely from a fully constructed VR environment.

At step 904, the method 900 may include identifying the OOI 204 from among the plurality of objects, in each of the first right eye image frame and the first left eye image frame. In an embodiment, identifying the OOI 204 is based on one or more of the eye gaze of the user by the HMD 202B, the head gaze of the user by the HMD 202B, a pointer, or a pre-defined marking in the input video frames 202A by a developer. Thus, the OOI 204 may be identified in the input video frames 202A based on the eye gaze of the user, where the HMD 202B tracks direction of the user's eyes to determine which object they are focusing on. In an embodiment, the OOI 204 may be identified in the input video frames 202A based on the head gaze of the user, where the HMD detects the user's head orientation to identify the OOI 204. In an embodiment, the OOI 204 may be identified through a pointer, such as a VR controller's laser pointer, or by a pre-defined marking in the input video frames, for instance, the highlighted area around the target object in the AR application. Further, the OOI 204 appears in foreground, which may refer to the part of the virtual environment that appears closest to the user.

In an embodiment, the method 900 may include identifying the ROIs in each of the first right eye image frame and the first left eye image frame that requires recognizing objects. The ROI refers to specific areas or regions within an image frame (from the input video frames 202A) for focused analysis, often defined by geometric boundaries such as rectangles or polygons. The use of the term OOI includes the term ROI, as the context may require.

At step 906, the method 900 may include obtaining a second left eye image frame and a second right eye image frame, respectively based on the first left eye image frame and the first right eye image frame. The second left eye image frame and the second right eye image frame include the object of interest from among the plurality of objects. The method 900 may include obtaining the second left eye image frame by segmenting the object of interest from the first left eye image frame. The method 900 may include obtaining the second right eye image frame by segmenting the object of interest from the first right eye image frame.

At step 908, the method 900 may include obtaining a center eye image frame by shifting at least one of the viewpoint of the left camera or the viewpoint of the right camera toward a center viewpoint.

For generating the center eye image frame, the method 900 may include generating a depth map for the object of interest in each of the first left eye image frame and the first right eye image frame. The depth map may, for example, refer to a graphical representation that shows distance of the plurality of objects in the scene from the user. The depth map may use varying shades of gray in which darker areas indicate objects farther away and lighter areas represent closer objects. The depth map may be used to enhance 3D perception by providing spatial context, enabling accurate detection, tracking, and interaction with objects in the scene. For instance, the depth map for the OOI 204 may be generated by LiDAR or depth information from hardware and depth estimation AI or depth map generator.

The method 900 may include generating a plurality of depth clusters from the generated depth map for the object of interest. The depth clusters may refer to groups of pixels within the depth map that share similar depth values, effectively categorizing the plurality of objects based on their distance from the user. When generating the depth clusters for the OOI, the depth map is analyzed to identify areas where depth information is consistent, allowing for segmentation of the scene into distinct layers or clusters. This process may help in isolating the OOI from the background.

The method 900 may include obtaining the IPD by segmenting the plurality of depth clusters. The IPD is the distance between the centers of the pupils of the eyes. The IPD affects how each eye perceives depth and 3D images. By accurately measuring the IPD, the center eye image may be adjusted to ensure that the visual content aligns correctly with the user's natural eye position, enhancing depth perception and reducing visual discomfort. The IPD may be determined from depth clusters by measuring disparity between corresponding points in the first left eye image frame and the first right eye image frame within the depth map. By analyzing the disparity across the depth clusters, the user's IPD may be obtained.

Further, the method 900 may include generating the center eye image frame by moving the viewpoint of at least one of the first left eye image frame towards center by half of the IPD or the first right eye image frame towards center by half of the IPD.

At step 910, the method 900 may include generating a background image frame by removing the object of interest from the center eye image frame and filling space of the removed object of interest.

In an embodiment, the method 900 may include identifying one or more overlapping objects from the center eye image frame. The one or more overlapping objects may refer to items that partially cover the object of interest from the user's center eye perspective. In response to identification of the one or more overlapping objects, the method 900 may include segmenting out the one or more overlapping objects from the at least one of the center eye image frame. The method 900 may include overlaying the one or more of overlapping objects on top of the third left eye image frame and the third right eye image frame.

At step 910, the method 900 may include generating the background image frame by removing the object of interest from the center eye image frame and filling the space of the object of interest. The background image may refer to a part of visual field that appears farthest from the user, including distant objects such as landscapes, skies, or walls. The background image provides context and depth to the virtual environment. In the center eye image frame (e.g., the center eye image as if using both the left viewpoint and the right viewpoint of eyes), the background helps establish spatial layout and depth cues. Further, in a non-limiting example, to fill the space of the object of interest in the background image frame, state-of-the-art (SOTA) models, such as deep learning-based inpainting networks may be used. The SOTA models fill in the space often using context from the surrounding areas.

At step 912, the method 900 may include generating the third left eye image frame and the third right eye image frame from the second left eye image frame, the second right eye image frame, and the background image frame. The third left eye image frame and the third right eye image frame from the second left eye image frame, the second right eye image frame and the background image frame frame may refer to the two slightly offset images generated to simulate depth perception in VR. The third left eye image frame represents view captured from the left eye's perspective, while the third right eye image frame represents the view from the right eye's perspective.

At step 914, the method 900 may include generating the stereoscopic view of the object of interest from the third left eye image frame and the third right eye image frame.

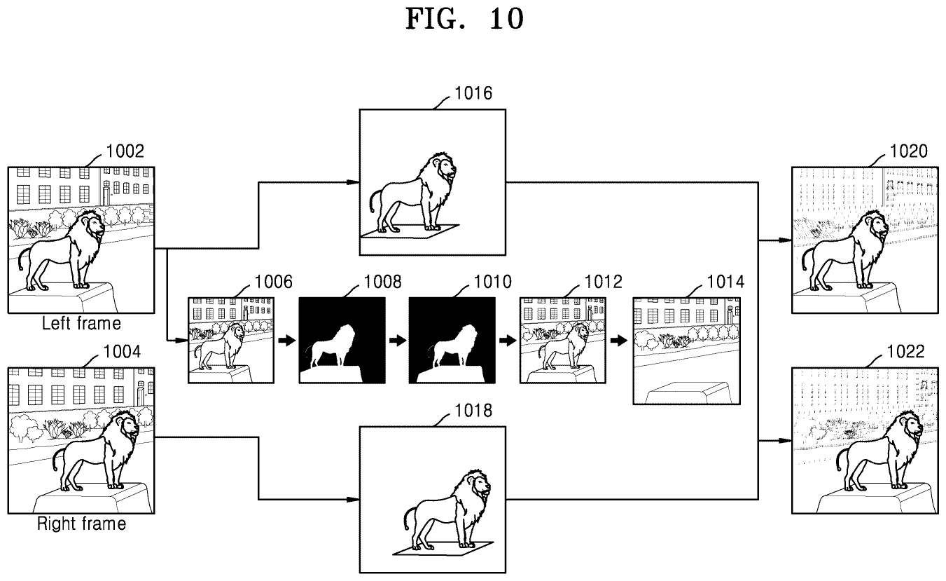

FIG. 10 illustrates an example of generating a stereoscopic view of an object, according to various embodiments of the present disclosure.

As shown, image 1002 and image 1004 are the first left eye image frame and the first right eye image frame respectively, which are received from input video frames (202A). From the first left eye image frame 1002 and the first right eye image frame 1004, the object of interest (i.e., lion) is identified. Image 1016 and image 1018 represent segmented OOI from the first left eye image frame 1002 and the first right eye image frame 1004 respectively. The first left eye image frame 1002 is considered as input 1006 for center eye image generator. At image 1008, depth map for the object of interest is performed. Then depth clusters are generated from the depth map and an interpupillary distance (IPD) is obtained by segmenting the depth clusters. At image 1010, camera position is shifted by IPD/2 mm towards the center to generate the center eye image frame 1012. Similar steps are performed with the first right eye image frame 1004 to generate the second right eye image frame 1018. Then, the background image 1014 is generated by removing the OOI from the center eye image and filling up the space. Image 1020 and image 1022 are the third left eye image frame and the third right eye image frame generated from the second left eye image frame 1016, the second right eye image frame 1018, and the background image frame 1014.

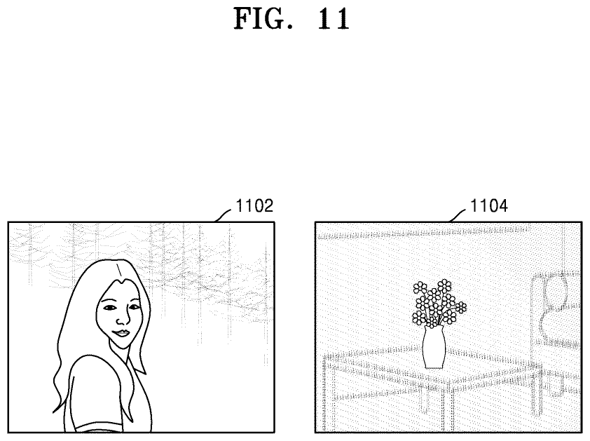

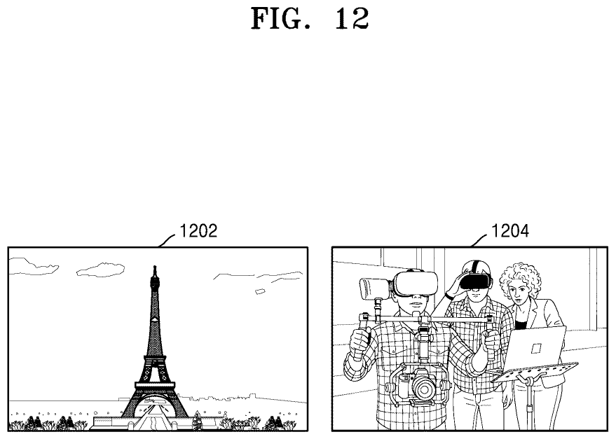

FIGS. 11 and 12 illustrate example use cases of generating a stereoscopic view of an object, according to various embodiments of the present disclosure.

As shown in FIG. 11, image 1102 indicates an application of the present disclosure in a distant AR field guidance. Using the present disclosure the instructor is able to highlight certain objects in selective stereoscopy for students (or the user) on the HMD from a different device.

Further, image 1104 indicates another application of the present disclosure in VR Attention guidance for tutorials and onboarding. Using the present disclosure, a developer may encode objects or regions that need to be heightened in order to experience a fixed user journey. In an embodiment, user interface elements may pop out in 3D while the rest of the elements may remain in 2D for an added layer of delight in VR.

FIG. 12 illustrates at image 1202 another application of the present disclosure that focuses on objects while sharing videos shot in HMDs. Further, image 1204 depicts an application of the present disclosure during VR narrative or filmmaking. Thus, in 3D videos and VR filmmaking, while 2D films use bokeh to emphasize subjects, VR (using the present disclosure) may achieve this through selective stereoscopy to highlight the subject and convey the creator's intent.

The present disclosure provides the advantage of giving way to a new type of viewing and highlighting in extended reality (XR) where information is highlighted meaningfully without breaking immersion and/or obstructing, occluding or emitting non-essential information.

As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not necessarily limited to the manner described herein.

Moreover, the actions of any signal flow diagram need not be implemented in the order shown; nor do all of the acts necessarily need to be performed. Also, those acts that are not dependent on other acts may be performed in parallel with the other acts.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

According to an embodiment of the disclosure, the method for generating a stereoscopic view of an object, may include obtaining a first left eye image frame and a first right eye image frame based on input video frames, wherein the first left eye image includes a plurality of objects captured from a viewpoint of a left camera, and the first right eye image includes the plurality of objects captured from a viewpoint of a right camera. The method may include identifying an object of interest from among the plurality of objects, in each of the first right eye image frame and the first left eye image frame. The method may include obtaining a second left eye image frame and a second right eye image frame, respectively based on the first left eye image frame and the first right eye image frame, wherein the second left eye image frame and the second right eye image frame include the object of interest from among the plurality of objects. The method may include obtaining a center eye image frame by shifting at least one of the viewpoint of the left camera or the viewpoint of the right camera toward a center viewpoint. The method may include generating a background image frame by removing the object of interest from the center eye image frame and filling space of the removed object of interest. The method may include generating a third left eye image frame from the second left eye image frame, and the background image frame, and generating a third right eye image frame from the second right eye image frame, and the background image frame. The method may include generating the stereoscopic view of the object of interest from the third left eye image frame and the third right eye image frame.

According to an embodiment of the disclosure, the input video frames may comprise one of a stereoscopic video captured from a 3-dimensional (3D) camera or a stereo camera.

According to an embodiment of the disclosure, the identifying of the object of interest may be based on one or more of an eye gaze of a user, a head gaze of the user, a pointer, or a pre-defined marking in the input video frames.

According to an embodiment of the disclosure, the method may include identifying one or more overlapping objects with the object of interest from the center eye image frame. The method may include in response to identification of the one or more of overlapping objects, segmenting out the one or more overlapping objects from the center eye image frame. The method may include overlaying the one or more of overlapping objects on top of the third left eye image frame and the third right eye image frame.

According to an embodiment of the disclosure, the method may include obtaining the second left eye image frame by segmenting the object of interest from the first left eye image frame. The method may include obtaining the second right eye image frame by segmenting the object of interest from the first right eye image frame.

According to an embodiment of the disclosure, the method may include generating a depth map for the object of interest at least one of the first left eye image frame or the first right eye image frame. The method may include generating a plurality of depth clusters from the generated depth map for the object of interest. The method may include obtaining an interpupillary distance (IPD) by segmenting the plurality of depth clusters. The method may include obtaining the center eye image frame by shifting the at least one of the viewpoint of the left camera or the viewpoint of the right camera towards the center by half of the IPD.

According to an embodiment of the disclosure, the method may include removing the object of interest from the center eye image frame. The method may include inpainting the space of the removed object of interest by using at least one of a blur or a generative AI.

According to an embodiment of the disclosure, an electronic device for generating a stereoscopic view of an object may be provided. The electronic device may comprise at least one processor comprising processing circuitry, and memory storing one or more instructions that, when executed by the at least one processor individually or collectively. The instructions that, when executed by the at least one processor individually or collectively, cause the electronic device to obtain a first left eye image frame and a first right eye image frame based on input video frames, wherein the first left eye image includes a plurality of objects captured from a viewpoint of a left camera, and the first right eye image includes the plurality of objects captured from a viewpoint of a right camera. The instructions that, when executed by the at least one processor individually or collectively, cause the electronic device to identify an object of interest from among the plurality of objects, in each of the first right eye image frame and the first left eye image frame. The instructions that, when executed by the at least one processor individually or collectively, cause the electronic device to obtain a second left eye image frame and a second right eye image frame, respectively based on the first left eye image frame and the first right eye image frame, wherein the second left eye image frame and the second right eye image frame include the object of interest from among the plurality of objects. The instructions that, when executed by the at least one processor individually or collectively, cause the electronic device to obtain a center eye image frame by moving at least one of the first left eye image frame or the first right eye image frame. The instructions that, when executed by the at least one processor individually or collectively, cause the electronic device to generate a background image frame by shifting at least one of the viewpoint of the left camera or the viewpoint of the right camera toward a center viewpoint. The instructions that, when executed by the at least one processor individually or collectively, cause the electronic device to generate a third left eye image frame from the second left eye image frame and the background image frame and generate a third right eye image frame from the second right eye image frame, and the background image frame. The instructions that, when executed by the at least one processor individually or collectively, cause the electronic device to provide the stereoscopic view of the object of interest from the third left eye image frame and the third right eye image frame.

According to the embodiment of the disclosure, the input video frames may comprise one of a stereoscopic video captured from a 3-dimensional (3D) camera or a stereo camera.

According to the embodiment of the disclosure, the instructions that, when executed by the at least one processor individually or collectively, cause the electronic device to identify the object of interest based on one or more of an eye gaze of a user, a head gaze of the user, a pointer, or a pre-defined marking in the input video frames.

According to the embodiment of the disclosure, the instructions that, when executed by the at least one processor individually or collectively, cause the electronic device to identify one or more overlapping objects with the object of interest from the center eye image frame. The instructions that, when executed by the at least one processor individually or collectively, cause the electronic device to, in response to identification of the one or more of overlapping objects, segment out the one or more overlapping objects from the center eye image frame. The instructions that, when executed by the at least one processor individually or collectively, cause the electronic device to overlay the one or more of overlapping objects on top of the third left eye image frame and the third right eye image frame

According to the embodiment of the disclosure, the instructions that, when executed by the at least one processor individually or collectively, cause the electronic device to obtain the second left eye image frame by segmenting the object of interest from the first left eye image frame. The instructions that, when executed by the at least one processor individually or collectively, cause the electronic device to obtain the second right eye image frame by segmenting the object of interest from the first right eye image frame.

According to the embodiment of the disclosure, the instructions that, when executed by the at least one processor individually or collectively, cause the electronic device to generate a depth map for the object of interest at least one of the first left eye image frame and the first right eye image frame. The instructions that, when executed by the at least one processor individually or collectively, cause the electronic device to generate a plurality of depth clusters from the generated depth map for the object of interest. The instructions that, when executed by the at least one processor individually or collectively, cause the electronic device to obtain an interpupillary distance (IPD) by segmenting the plurality of depth clusters. The instructions that, when executed by the at least one processor individually or collectively, cause the electronic device to obtain the center eye image frame by shifting the at least one of the viewpoint of the left camera or the viewpoint of the right camera towards the center by half of the IPD.

According to the embodiment of the disclosure, the instructions that, when executed by the at least one processor individually or collectively, cause the electronic device to remove the object of interest from the center eye image frame. The instructions that, when executed by the at least one processor individually or collectively, cause the electronic device to inpaint the space of the removed object of interest by using at least one of a blur or a generative AI.

According to the embodiment of the disclosure, a non-transitory computer readable storage medium containing instructions that when executed cause at least one processor of an electronic device may be provided.

What is claimed is:

1. A method for generating a stereoscopic view of an object, comprising:
obtaining a first left eye image frame and a first right eye image frame based on input video frames, wherein the first left eye image includes a plurality of objects captured from a viewpoint of a left camera, and the first right eye image includes the plurality of objects captured from a viewpoint of a right camera;
identifying an object of interest from among the plurality of objects, in each of the first right eye image frame and the first left eye image frame;
obtaining a second left eye image frame and a second right eye image frame, respectively based on the first left eye image frame and the first right eye image frame, wherein the second left eye image frame and the second right eye image frame include the object of interest from among the plurality of objects;
obtaining a center eye image frame by shifting at least one of the viewpoint of the left camera or the viewpoint of the right camera toward a center viewpoint;
generating a background image frame by removing the object of interest from the center eye image frame and filling space of the removed object of interest;
generating a third left eye image frame from the second left eye image frame, and the background image frame, and generating a third right eye image frame from the second right eye image frame, and the background image frame; and
generating the stereoscopic view of the object of interest from the third left eye image frame and the third right eye image frame.

2. The method as claimed in claim 1, wherein the input video frames comprise one of a stereoscopic video captured from a 3-dimensional (3D) camera or a stereo camera.

3. The method as claimed in claim 1, wherein identifying of the object of interest is based on one or more of an eye gaze of a user, a head gaze of the user, a pointer, or a pre-defined marking in the input video frames.

4. The method as claimed in claim 1, further comprising:
identifying one or more overlapping objects with the object of interest from the center eye image frame;
in response to identification of the one or more of overlapping objects, segmenting out the one or more overlapping objects from the center eye image frame; and
overlaying the one or more of overlapping objects on top of the third left eye image frame and the third right eye image frame.

5. The method as claimed in claim 1, wherein the obtaining of the second left eye image frame and the second right eye image frame comprises:
obtaining the second left eye image frame by segmenting the object of interest from the first left eye image frame; and
obtaining the second right eye image frame by segmenting the object of interest from the first right eye image frame.

6. The method as claimed in claim 1, wherein obtaining of the center eye image frame comprises:
generating a depth map for the object of interest at least one of the first left eye image frame or the first right eye image frame;
generating a plurality of depth clusters from the generated depth map for the object of interest;
obtaining an interpupillary distance (IPD) by segmenting the plurality of depth clusters; and
obtaining the center eye image frame by shifting the at least one of the viewpoint of the left camera or the viewpoint of the right camera towards the center by half of the IPD.

7. The method as claimed in claim 1, wherein the generating of the background image frame comprises:
removing the object of interest from the center eye image frame; and
inpainting the space of the removed object of interest by using at least one of a blur or a generative AI.

8. An electronic device for generating a stereoscopic view of an object, the electronic device comprising:
at least one processor comprising processing circuitry;
memory storing one or more instructions that, when executed by the at least one processor individually or collectively, cause the electric device to:
obtain a first left eye image frame and a first right eye image frame based on input video frames, wherein the first left eye image includes a plurality of objects captured from a viewpoint of a left camera, and the first right eye image includes the plurality of objects captured from a viewpoint of a right camera;
identify an object of interest from among the plurality of objects, in each of the first right eye image frame and the first left eye image frame;
obtain a second left eye image frame and a second right eye image frame, respectively based on the first left eye image frame and the first right eye image frame, wherein the second left eye image frame and the second right eye image frame include the object of interest from among the plurality of objects;
obtain a center image frame by shifting at least one of the viewpoint of the left camera or the viewpoint of the right camera toward a center viewpoint;
generate a background image frame by removing the object of interest from the center eye image frame and filling space of the removed object of interest;
generate a third left eye image frame from the second left eye image frame and the background image frame and generate a third right eye image frame from the second right eye image frame, and the background image frame; and
generate the stereoscopic view of the object of interest from the third left eye image frame and the third right eye image frame.

9. The electronic device as claimed in claim 8, wherein the input video frames comprise one of a stereoscopic video captured from a 3-dimensional (3D) camera or a stereo camera.

10. The electronic device as claimed in claim 8, wherein the instructions that, when executed by the at least one processor individually or collectively, cause the electronic device to:
identify the object of interest based on one or more of an eye gaze of a user, a head gaze of the user, a pointer, or a pre-defined marking in the input video frames.

11. The electronic device as claimed in claim 8, wherein the instructions that, when executed by the at least one processor individually or collectively, cause the electronic device to:
identify one or more overlapping objects with the object of interest from the center eye image frame;
in response to identification of the one or more of overlapping objects, segment out the one or more overlapping objects from the center eye image frame; and
overlay the one or more of overlapping objects on top of the third left eye image frame and the third right eye image frame.

12. The electronic device as claimed in claim 8, wherein the instructions that, when executed by the at least one processor individually or collectively, cause the electronic device to:
obtain the second left eye image frame by segmenting the object of interest from the first left eye image frame; and
obtain the second right eye image frame by segmenting the object of interest from the first right eye image frame.

13. The electronic device as claimed in claim 8, wherein the instructions that, when executed by the at least one processor individually or collectively, cause the electronic device to:
generate a depth map for the object of interest at least one of the first left eye image frame and the first right eye image frame;
generate a plurality of depth clusters from the generated depth map for the object of interest;
obtain an interpupillary distance (IPD) by segmenting the plurality of depth clusters; and
obtain the center eye image frame by shifting the at least one of the viewpoint of the left camera or the viewpoint of the right camera towards the center by half of the IPD.

14. The electronic device as claimed in claim 8, wherein the instructions that, when executed by the at least one processor individually or collectively, cause the electronic device to:
remove the object of interest from the center eye image frame; and
inpaint the space of the removed object of interest by using at least one of a blur or a generative AI.

15. A non-transitory computer readable storage medium containing instructions that when executed cause at least one processor of an electronic device to:
obtain a first left eye image frame and a first right eye image frame based on input video frames, wherein the first left eye image includes a plurality of objects captured from a viewpoint of a left camera, and the first right eye image includes the plurality of objects captured from a viewpoint of a right camera;
identify an object of interest from among the plurality of objects, in each of the first right eye image frame and the first left eye image frame;
obtain a second left eye image frame and a second right eye image frame, respectively based on the first left eye image frame and the first right eye image frame, wherein the second left eye image frame and the second right eye image frame include the object of interest from among the plurality of objects;
obtain a center eye image frame by shifting at least one of the viewpoint of the left camera or the viewpoint of the right camera toward a center viewpoint;
generate a background image frame by removing the object of interest from the center eye image frame and filling space of the removed object of interest;
generate a third left eye image frame from the second left eye image frame and the background image frame and generating a third right eye image frame from the second right eye image frame, and the background image frame; and
provide the stereoscopic view of the object of interest from the third left eye image frame and the third right eye image frame.

16. The non-transitory computer readable storage medium as claimed in claim 15, wherein the instructions that when executed cause at least one processor of the electronic device to:
identify the object of interest based on one or more of an eye gaze of a user, a head gaze of the user, a pointer, or a pre-defined marking in the input video frames.

17. The non-transitory computer readable storage medium as claimed in claim 15, wherein the instructions that when executed cause at least one processor of the electronic device to:
identify one or more overlapping objects with the object of interest from the center eye image frame;
in response to identification of the one or more of overlapping objects, segment out the one or more overlapping objects from the center eye image frame; and
overlay the one or more of overlapping objects on top of the third left eye image frame and the third right eye image frame.

18. The non-transitory computer readable storage medium as claimed in claim 15, wherein the instructions that when executed cause at least one processor of the electronic device to:
obtain the second left eye image frame by segmenting the object of interest from the first left eye image frame; and
obtain the second right eye image frame by segmenting the object of interest from the first right eye image frame.

19. The non-transitory computer readable storage medium as claimed in claim 15, wherein the instructions that when executed cause at least one processor of the electronic device to:
generate a depth map for the object of interest at least one of the first left eye image frame and the first right eye image frame;
generate a plurality of depth clusters from the generated depth map for the object of interest;
obtain an interpupillary distance (IPD) by segmenting the plurality of depth clusters; and
obtain the center eye image frame by shifting the at least one of the viewpoint of the left camera or the viewpoint of the right camera towards the center by half of the IPD.

20. The non-transitory computer readable storage medium as claimed in claim 15, wherein the instructions that when executed cause at least one processor of the electronic device to:
remove the object of interest from the center eye image frame; and
inpaint the space of the removed object of interest by using at least one of a blur or a generative AI.
